(19) United States
(12) Patent Application Publication
(10) Pub. No.: US 2004/0252992 A1
(43) Pub. Date: Dec. 16, 2004

(54) Digital camera with removable imaging module

(76) Inventor: Andrew Arthur Hunter, Bristol (GB)

Correspondence Address: HEWLETT-PACKARD COMPANY, Intellectual Property Administration, P.O. Box 27240, Fort Collins, CO, 80527-2400, US

(21) Appl. No.: 10/818,304

(22) Filed: Apr. 5, 2004

(30) Foreign Application Priority Data
Apr. 10, 2003 (GB) 0308304.5

(51) Int. Cl. G03B 17/02

(52) U.S. Cl. 396/535

(57) ABSTRACT

A digital camera disclosed herein comprises a lens, a digital image sensor to receive an image from the lens, and a digital image storage device. The image sensor and image storage device are packaged together as an integral imaging module, which is adapted to be assembled into and disassembled from the digital camera as an integral unit. The integral imaging module and the remaining parts of the digital camera may therefore be purchased or otherwise provided separately.

### FIELD OF THE INVENTION

The present application is generally related to digital cameras. More particularly, the present application is related to digital cameras with removable imaging modules.

### BACKGROUND

Digital still cameras have gained relatively wide acceptance over recent years and are beginning to rival traditional film-based cameras. The major constraints that have now largely been addressed are the availability, affordability, and easy handling of high storage capacity memory for storing the high pixel density of captured images, giving a quality that rivals film recorded images.

Newer high data capacity flash memory devices include SmartMedia™ and CompactFlash™. These fast operating devices contain non-volatile memory so that captured image data is not at risk of loss due to power failure. Both are in the form of self-contained storage cards with the memory chip encased in a plastic sheath. In the SmartMedia™ memory chip, a plane electrode and bonding wires of the device are embedded in plastic resin forming an ultra-slim package which is glued to a rigid base card without the need for soldering. In CompactFlash™, the memory chip is partnered with a control chip and is encased in a more rugged plastic and metal shell with multi-pin contacts for power and data transfer arranged in two rows at an edge of the casing.

Each of these flash memory devices is thus designed to be easily removable from the camera for transfer to an interface with a PC or smart printer and/or to be replaced with another identical storage card with free memory or, indeed, a higher capacity card. With falling prices of such memory devices, digital cameras are now more affordable than ever, but they still remain unable to compete with film-based cameras in some areas, and particularly in the disposable camera market.

The most affordable digital cameras currently available are generally unsophisticated and are typically based on the cheapest components—a cheaply molded low quality plastic camera body with a transparent plastic lens, a low quality/low image density image capture device, and a restricted capacity memory capable of storing only a few images. Often there is no provision for access to the memory for removal and replacement. The limited number of relatively low quality images that are taken are intended to be uploaded to a PC for the camera to be used again. Such cameras do not have the necessary combination of reasonable quality, storage capacity, and sufficiently low cost for viable use as disposable cameras.

There remains a need for a digital camera arrangement that provides benefits and attributes of disposable film-based cameras such as reasonable image quality, low manufacturing cost, low consumer cost, and operation convenience for the consumer. One of the major convenience benefits of disposable film-based cameras and which contributes greatly to their attractiveness is the freedom to purchase an inexpensive, compact, and relatively lightweight camera at convenient locations, such as an airport or corner store. These disposable cameras can be used as a substitute for more expensive and often heavier or bulkier main cameras.

To date there are very few digital camera systems that have been proposed to provide the benefits of disposable cameras. In U.S. Pat. No. 6,231,148, a digital camera is described for use as a disposable camera by virtue of having a low cost built-in printing facility. The desired attributes of quality, size of obtainable images, and cost of the camera will nevertheless inherently be compromised, not enhanced, by the provision of the on-board printing facility.

A further digital camera system, proposed to have some of the benefits of disposable cameras, is described in US Patent Application No. 2001/0040625. This application proposes use of an on-board transmitter built into the digital camera for transmitting image data to a web site or the like so that the user can effectively lease the camera from a supplier for a single use. After use, the user returns the camera to the supplier and can subsequently access the images from the website. This imposes obvious limitations on users, obliging them to look after the leased camera, return the whole camera after use, and access the Internet or other network to gain access to their images.

### SUMMARY

According to a first aspect of the present invention there is provided a digital camera comprising a lens, a digital image sensor to receive an image from the lens, and a digital image storage device, wherein the image sensor and image storage device are packaged together as an integral imaging module which is adapted to be assembled into and disassembled from the digital camera as an integral unit.

### BRIEF DESCRIPTION OF THE DRAWINGS

Preferred embodiments will now be more particularly described, by way of example, with reference to the accompanying drawings wherein:

FIG. 1 is a front elevation view of an assembled modular digital camera of a first preferred embodiment, comprising an imaging module housed in a camera body module;

FIG. 2 is a side elevation view of the camera body module shown in FIG. 1;

FIG. 3 is a schematic front elevation view of an embodiment of an imaging module with its protective casing not shown;

FIG. 4 is a front elevation view of an embodiment of an imaging module's protective casing;

FIG. 5 is a front elevation view of another embodiment of an imaging module's protective casing;

FIG. 6 is a front elevation view of another embodiment of an imaging module's protective casing;

FIG. 7 is a front elevation view of yet another embodiment of an imaging module's protective casing;

FIG. 8 is a rear perspective view of a second preferred embodiment of a camera body module having a hinged rear door, shown in an open position;

FIG. 9 is a top elevation view of the second preferred embodiment and an imaging module not installed in the camera body module; and

FIG. 10 is a top sectional view of the second preferred embodiment showing the imaging module installed in the camera body module and the rear door of the camera body module closed.

### DETAILED DESCRIPTION OF THE PREFERRED EMBODIMENTS

According to a first aspect of the present application, there is provided a digital camera comprising a camera body module and a removable imaging module. The imaging module comprises a digital image sensor that receives or senses an image, such as from a lens of the camera body module. The imaging module also comprises a digital image storage device that stores the received image. The image sensor and image storage device are packaged together as an integral imaging module, which is adapted to be installed into and removed from the camera body module as an integral unit.

In a particularly simple embodiment, the camera body may comprise solely a camera lens (optical element plus barrel casing) to which the imaging module is mounted during use. Preferably, however, the camera body further comprises a housing to accommodate operating components of the camera. In addition to incorporating a lens, the camera body module suitably further incorporates a viewfinder, a battery and, if one is required, a flash mechanism. The camera body may also comprise a housing adapted to accommodate the imaging module.

There is provided a camera body comprising a lens but not comprising an image sensor or an image storage device. The camera body is suitably dimensioned to accommodate an imaging module, which comprises at least an image sensor and an image storage device, but does not comprise a lens. The camera body may include a guide to substantially correctly position the imaging module relative to the lens when the imaging module is fully inserted in the camera body.

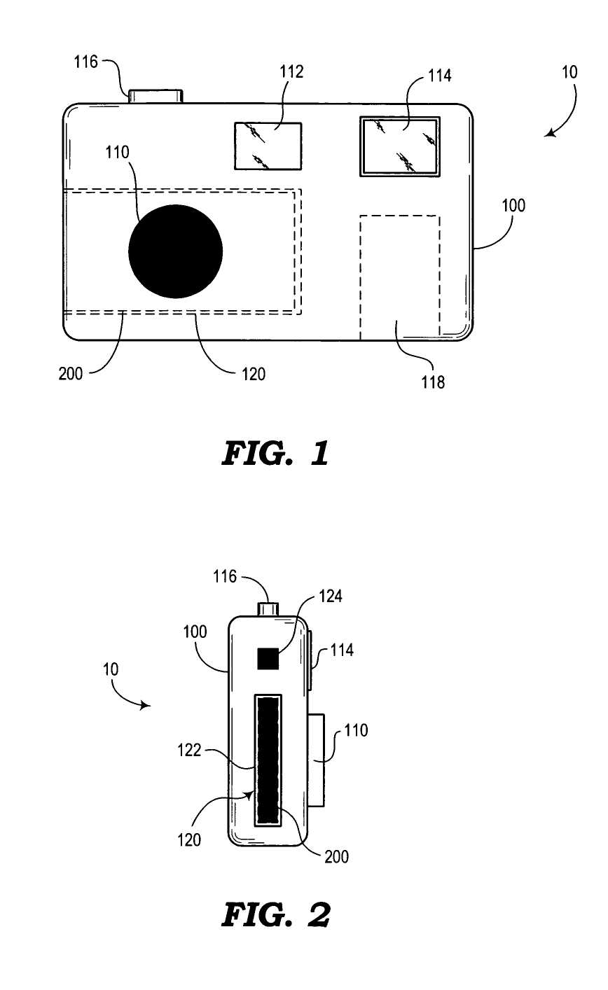

Referring to FIG. 1, a first embodiment of a modular digital camera 10 is illustrated having a camera body module 100 and an imaging module 200. The camera body module 100 may be of substantially conventional construction for a digital still camera body and may comprise a robust plastic molding, incorporating a lens 110, viewfinder 112, flash mechanism 114, shutter actuating button 116 and battery compartment 118. The camera body module 100 is not specifically configured to controllably expose or wind conventional film. The interior of the camera body module 100 has a specially adapted chamber 120 for securely housing the imaging module 200, which comprises the electronic components of the modular digital camera in an accessible manner.

The chamber 120 is dimensioned to accommodate the imaging module 200. The camera body module 100 has an access slot or opening to enable insertion and removal of the imaging module 200 into the chamber 120. The access slot or opening may be covered by a door that suitably is hinged. An ejector is suitably provided to eject the imaging module 200 from within the camera body module 100. The camera body module 100 further incorporates a guide to position the imaging module 200 relative to the lens 110 when the imaging module 200 is fully inserted in the camera body module 100.

Referring to FIG. 2, the chamber 120 also allows easy access to the imaging module 200 for its removal and replacement. A suitably dimensioned door-covered access slot 122 is provided in one side of the body module 100 to allow sliding insertion and removal of the imaging module 200. A push-button operated spring-biased ejection mechanism is provided having a push button 124 adjacent the slot 122 to facilitate removal of the imaging module 200 from the chamber 120.

The imaging module 200 is generally readily removable from and re-mountable to the camera body 100 but in one embodiment may be locked in place in the camera body. In this case, a tool, for example but not limited to a key, can be used for release to prevent unauthorized separation.

The imaging module 200 can be separated from the camera body module 100 after the user has taken a desired set of images. This allows the user to, for example, dispose of the camera body module 100 or leave the camera body module 100 at home for later re-use. It also allows the user to visit a printing shop or send the imaging module 200 to a printing shop and/or to upload the images stored in the imaging module 200 to a smart printer, PC, or other device. The stored images may thus be accessed to free up the memory in the imaging module 200 and allow the imaging module 200 to be returned to and re-used by the user or to be re-cycled.

Since the lifespan of the lens, battery, and, if any, flash mechanism is relatively short compared to the components of the imaging module 200, it would be desirable to confine the lens, battery, and flash mechanism to an inexpensive camera body module 100. The camera body module 100 with its shorter lifespan components can thus appropriately and easily be discarded and replaced after fewer cycles of use than the imaging module 200.

Preferably, the imaging module 200 further comprises an analog-to-digital converter and a processor. When needed, the processor may serve to construct and/or enhance a digital image derived from data from the image sensor and/or to compress the data for storage. The image sensor and image storage device, and suitably also the image processor, are preferably mounted on a common backing board, e.g., a printed circuit board (PCB).

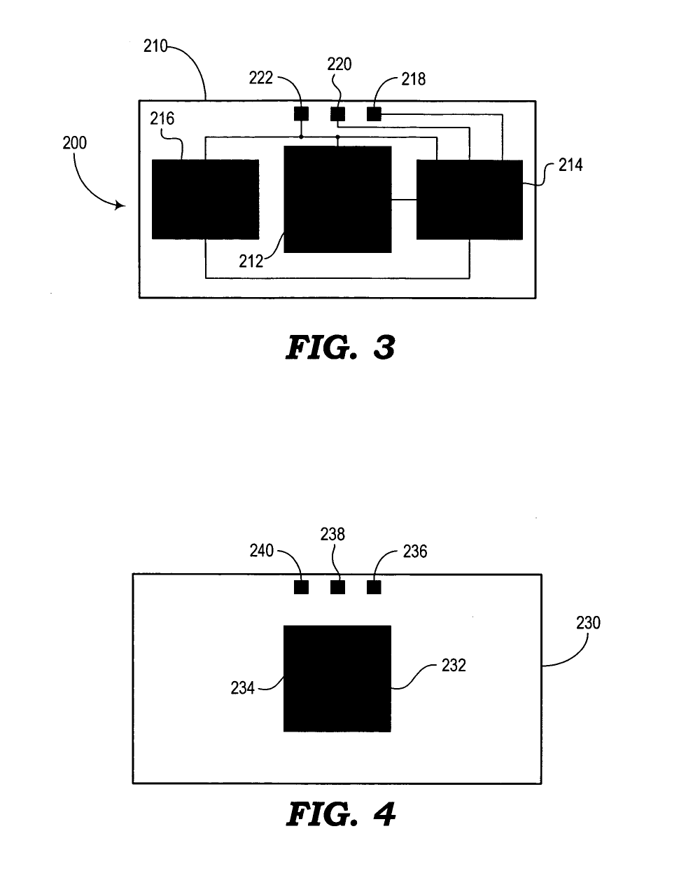

Referring to FIG. 3, an embodiment of an imaging module 200 is illustrated in which the imaging module 200 comprises a rigid backing board 210, for example but not limited to a PCB, onto which are mounted an image sensor 212, an image processor 214, and an image storage device 216. The image processor 214 processes images received from the image sensor 212 and is electrically coupled to the camera body module 100 via contacts 218, 220, 222 for controlling operation of the camera. The contacts 218, 220, 222 provide an interface between the imaging module 200 and the shutter-actuating button 116, flash mechanism 114, and the batteries in battery compartment 118, respectively. It should be noted, however, that although three contacts are shown and described, the imaging module 200 may contain fewer or more than three contacts for electrically coupling the electronic components of the imaging module 200 with the power and functional components of the camera body module 100. The contacts and connections of the imaging module 200 are illustrated schematically and may contain more than a single electrical path. Some or all of the contacts may conform to the format of conventional industry standard storage cards. In this way, when the imaging module 200 is removed from the camera body module 100, the contacts can communicate with equipment designed with respect to the format of these storage cards.

The image sensor 212, image processor 214, and image storage device 216 each may be formed separately and then integrally assembled together with each other as a package to form imaging module 200. Alternatively, the components may be formed in a single manufacturing step. Imaging module 200 is a self-contained, readily removable, independently transportable, and replaceable unit. The chamber 120 of the camera body module 100 (FIG. 1) is arranged to closely accommodate the imaging module 200 and is formed to guide it when it is inserted into the camera body module 100 so that the image sensor 212 is correctly positioned relative to the lens 110 for operation.

The imaging module 200 preferably comprises an essentially flat, card-like format, for example but limited to a PCB, for supporting the components of the imaging module 200. With such a card-like structure, the imaging module 200 may be easily inserted into the camera body module 100, easily connected to a card reader, and easily stored, handled, or delivered. The card may be dimensioned and configured as an industry standard storage card and operated similarly thereto when it is outside the camera body module 100.

Although not particularly limited to such an arrangement, the image sensor 212 of the imaging module 200 may preferably be a complementary metal oxide semiconductor (CMOS) image sensor, for example, rather than a charge coupled device (CCD) sensor that is typically favored in the majority of digital cameras. Although not of the highest quality, CMOS image sensors are admittedly cheaper to manufacture than CCD sensors. Another advantage of using CMOS image sensors is that they can be readily integrated with the other elements of the imaging module 200 to ensure space efficiency and compactness of the design. Data bits can be read from the CMOS image sensor for processing by the processor 214 and writing into the storage device 216, without requiring a separate chip to serve as a driver and analog-to-digital converter.

The processor 214 may contain an image processing part to interpolate the data from each pixel of the image sensor 212 and/or to provide the function of compressing the data, by, for example but not limited to, JPEG compression, to facilitate optimally compact storage of the image data in the storage device 216.

The image storage device 216 preferably comprises a flash memory, such as, for example but not limited to, the type used in CompactFlash™ memory cards, mounted to the backing board 210 of the imaging module 200. If desired, the imaging module 200 may be dimensioned and configured to conform generally to the specifications of the CompactFlash™ standard or to the specification of another suitable industry standard storage card.

Operational control of the digital camera is carried out by the control part of the processor 214, or, as an alternative embodiment, by a linked separate control processor. Such control of the digital camera can be carried out using conventional methods. The control part of the processor 214 is linked via contact 218 to the shutter-actuating button 116. When the actuating button 116 is triggered, the processor 214 activates an electronic shutter operation and, if needed, the flash mechanism 3.

The electronic shutter operation may include, for example but not limited to, an instantaneous reset operation. In this regard, the processor 214 enables all sensing pixels of the image sensor 212 to sense light simultaneously when the actuating button 116 is actuated and then disables all sensing pixels together. The instantaneous reset for the electronic shutter operation is preferred over electronic rolling reset shutters since the latter are vulnerable to skew, particularly with moving subjects.

In one embodiment, as the shutter is released, the pixels of the image sensor 212 are reset to a reference voltage. Exposure to light depletes the electrical charge until the timed period ends. The analog-to-digital converter associated with the image sensor 212 measures the remaining charge and creates a digital signal representing the value of the charge at each pixel. This digital signal is forwarded to the image processing part of the processor 214 for interpolation of the data to create natural color in the image. The processor 214 may compress the data to a desired level and transfer the data to the storage device 216.

The image storage device 216 suitably comprises a non-volatile flash memory device such as, for example but not limited to, that used in CompactFlash™ memory cards and the imaging module 200 may be configured to conform generally to the CompactFlash™ standard or other storage card standard. Preferably the imaging module 200 is adapted for direct connection to an interface of a device for communication therewith. The device may be, for example but not limited to, a printer, personal computer, or other suitable device for accessing images from the image storage device for printing, processing, etc.

For handling the imaging module 200 when it has been removed from the camera body module 100, the imaging module 200 is suitably ensheathed in a protective casing. The protective casing may be entirely transparent or as an alternative embodiment may have a transparent cover or window for visually exposing the image sensor. Alternatively or additionally, the imaging module may be provided with a removable cover for the image sensor, which cover may be removed before, during, or after installation of the imaging module and may be disposable.

Where the imaging module 200 is ensheathed in a protective casing, the protective casing preferably has an aperture to operatively expose the imaging sensor and/or one or more openings to expose at least one of the contacts of the imaging module. Furthermore, the protective casing preferably has one or more cover elements to cover the sensor-exposing aperture and/or the contact-exposing openings when the imaging module 200 is not within the camera body module 100. Where provided, the cover elements are suitably biased to cover the aperture and openings and cooperates with the camera body when the imaging module is inserted into the camera body to move the cover elements to expose the image sensor and/or contacts.

Referring to FIGS. 4-7, the backing board 210 of FIG. 3, with the electronic components 212, 214, and 216 mounted thereon, is ensheathed in exemplary embodiments of various protective casings, which protect the vulnerable parts of the imaging module 200 that would otherwise be exposed when the imaging module 200 is uncoupled from the camera body module 100. Specifically, the protective casings protect the sensing face of the image sensor 212 and the contacts 218, 220, 222.

Referring to FIG. 4, a first embodiment of a protective casing 230 for protecting the imaging module 200 is illustrated. The protective casing 230 includes an aperture 232 for exposing the image sensor 212. The aperture 232 may comprise a transparent cover 234 for protecting the sensor 212, yet allowing light from an image to pass through to the sensor 212. The protective casing 230 further includes openings 236, 238, and 240 for exposing the contacts 218, 220, and 222. More or fewer openings in the protective casing 230 may be provided depending on the number of contacts on the imaging module 200. In place of individual openings for each contact, the protective casing 230 may be designed with a single opening that exposes all the contacts.

In a further arrangement, the image sensor 212 may be protected prior to installation by provision of a removable cover such as, for example but not limited to, a protective film of acetate or other suitable material, which is releasably adhered in place across the aperture 232 and over the image sensor 212. The removable cover protects the image sensor 212 before use and can be removed, such as by peeling off, before, during, or after installation of the imaging module 200 into the camera body module 100. If designed to be removed during or after installation, the removable cover may include one or more extension strips, for example, that extend out of the access slot 122 for enabling the user to pull the removable cover from the chamber 120.

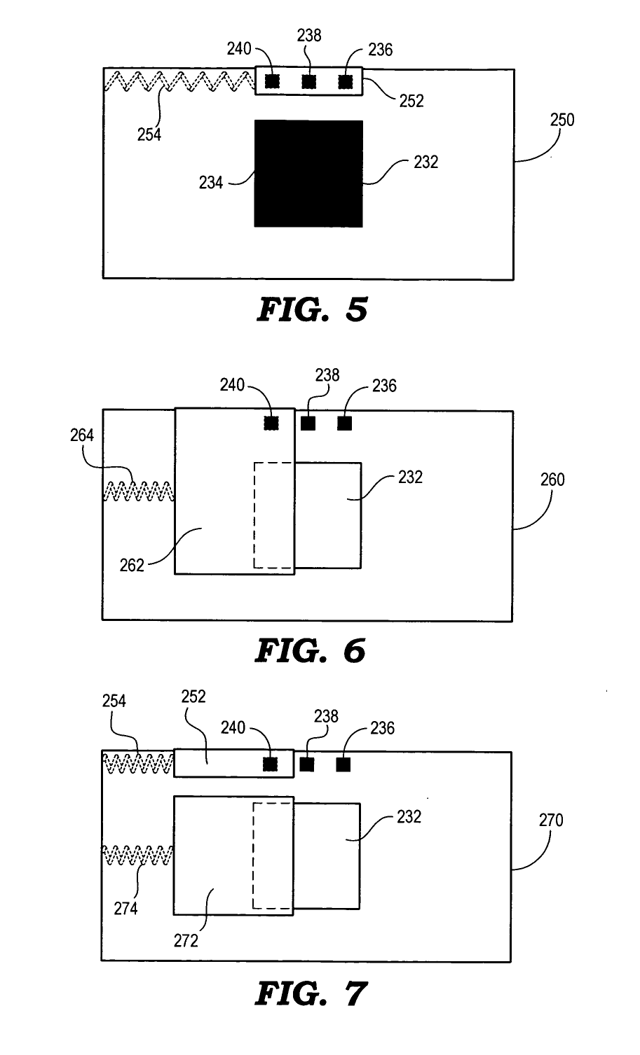

Referring to FIG. 5, another embodiment of a protective casing 250 is illustrated. The protective casing 250 suitably encases the whole imaging module 200 but has an aperture 232 with an optically transparent cover 234 that overlies the image sensor 212. The casing 250 includes openings 236, 238, 240 that expose the contacts 218, 220, and 222 when the imaging module 200 is installed in the camera body module 100. The openings 236, 238, and 240 are covered by a sliding cover element 252. The sliding cover element 252 is arranged to engage detents in the chamber 120 of the camera body module 100 when the imaging module 200 is inserted through the access slot 122 and into the chamber 120, thereby sliding the cover element 252 to expose the contacts 218, 220, 222. The cover element 252 is resiliently biased by a spring 254 to return to its closure position protecting the contacts 218, 220, 222 when the imaging module 200 is subsequently retracted and removed from within the chamber 120 of the camera body module 100.

In order to subsequently access the images held in the storage device 216, the user simply needs to remove the imaging module 200 from within the camera body module 100 using the ejector mechanism, by pressing the button 124 of the ejector mechanism on the side of the camera body module 100. As noted above, as the imaging module 200 is ejected, the cover element 252 of the imaging module's casing 250 will return to its position covering the contacts 218, 220, 222 and protecting the module 200 from damage by static charges, dust, dirt, grease, or other matter that can negatively affect the integrity of the module 200. The imaging module 200 is then free to be taken or dispatched to a processing facility to have the images uploaded to a computer, printer, or the like. The imaging module 200 may be returned to the user for re-use or to be recycled by recombination with the same or another camera body module 100. As noted previously, the user and supplier further have the option for the user to surrender the complete camera, if preferred.

Referring to FIG. 6, the image sensor 212 and contacts 218, 220, 222 may be protected by, in an alternative embodiment, a protective casing 260 having cover element 262. When the imaging module 200 is installed in the camera body module 100, the cover element 262 slides in a direction to compress the spring 264, thereby moving the cover element 262 to expose the image sensor 212 through aperture 232 in the casing 260 and to expose the contacts 218, 220, 222 through openings 236, 238, 240. When the imaging module 200 is removed from the camera body module 100, the spring 264 applies a force to the cover element 262 to position it in a closed position. Consequently, this movement of the cover element 262 positions the cover element 262 so as to protect the image sensor 212 and contacts 218, 220, 222.

Referring to FIG. 7, another alternative embodiment of a protective casing 270 is illustrated. In this embodiment, a sensor cover 272 is formed separately from the cover element 252. The sensor cover 272 is biased by a second spring element 274 to cover the aperture 232 when the imaging module 200 is removed from the camera body module 100. Additionally, the sensor cover 272 may contain a structure that engages additional detents within the chamber 120 causing the sensor cover 272 to slide in a direction to compress the second spring element 274 and expose the image sensor 212.

The lightness and compactness of the different embodiments of protective casings 230, 250, 260, and 270 and the imaging module 200 itself, with its thin, small and robust components, make it eminently convenient for handling, storage, and carriage (including postage if necessary) without the camera body module 100. The fragile and bulky parts of the modular digital camera are confined to the camera body module 100.

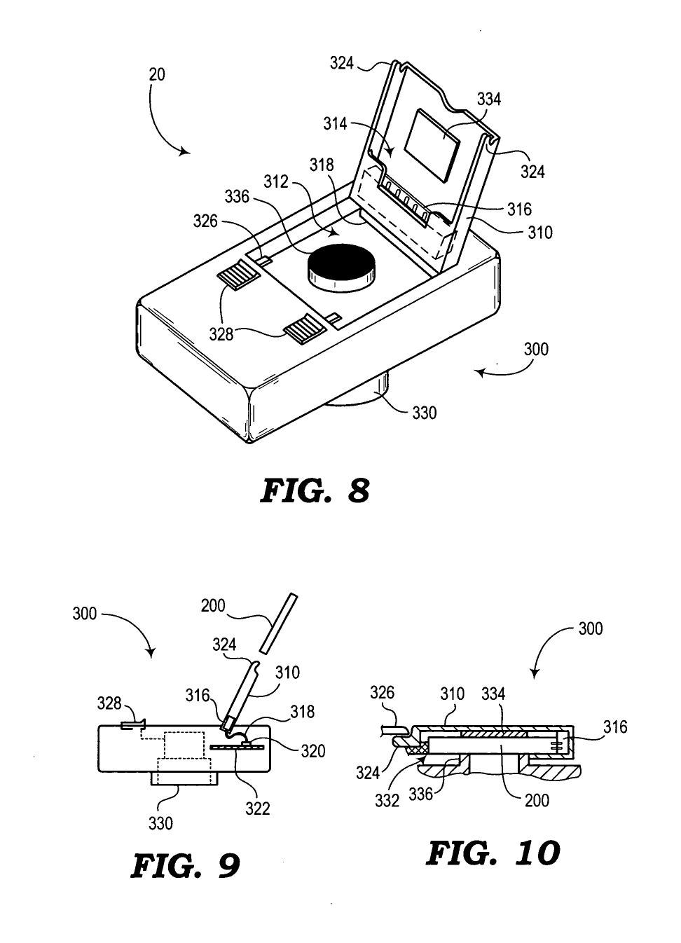

Referring now to FIGS. 8 to 10, a second alternative embodiment of a modular digital camera 20 is illustrated having a camera body module 300 and an imaging module 200. The camera body module 300 differs from that of the first embodiment primarily in that the robust plastic molding of the body has, instead of a side access slot, a hinged rear door 310 to access an interior chamber 312 from the rear and which also provides a convenient mount for the imaging module 200.

The door 310 is formed with a pocket 314 into which the imaging module 200 is inserted by sliding into place. A multi-pin electrical connector block 316 is located within the base of the pocket 314 and couples with the contacts 218, 220, 222 of the imaging module 200. The contacts 218, 220, 222 of the imaging module 200 may take the form of corresponding sockets on the leading edge of the imaging module 200 and the pins of the multi-pin connector block 316 fit into the sockets as the module 200 is inserted into the pocket 314. A flexible ribbon connector 318 links the connector block 316 in the door 310 to the contacts 320 of a PCB 322 that in turn links to the battery, shutter-operating button and flash mechanism of the camera body 300.

Closure of the illustrated door 310 brings latching lugs 324 on the free edge of the door 310 into cooperative engagement with resiliently biased catches 326 on the body 300 to hold the door 310 closed. Release sliders 328 are provided to enable re-opening of the door 310. The closure of the door 310 not only secures the imaging module 200 within the chamber 312 of the camera body 300 but also positions the imaging module 200 so that the image sensor 212 is aligned with the lens 330 and firmly engaged with the connector block 316. As the door 310 closes, guide edge 332 of the camera body 300 presses the imaging module 200 in a direction to urge the contact sockets of the imaging module 200 more firmly into engagement with the pins of the connector block 316 and constraining the module 200 laterally relative to the lens 330.

The imaging module 200 is also illustrated as being resiliently pressed towards the lens 330 by an elastomeric pressure pad 334 on the internal face of the door 310. The imaging module 200 is urged to seat securely flat against a prominent rim 336 that encircles the internal face of the lens 330, thereby further ensuring that the image sensor 212 is in precise alignment with the lens 330. The rim 336 is suitably an internal extension of the barrel of the lens 330.

By dividing the digital camera into two modules as described above it becomes possible for a high-tech electronics company specializing in high density circuit assembly using techniques such as multi-layer PCBs and surface mount components to economically mass-produce the imaging module while a low-tech company specializing in product assembly using combinations of mechanical and simpler electronic parts may independently economically mass-produce the camera body module of the digital camera. Assembly of the two modules to form the digital camera is very simple and may be done by the consumer or retailer, allowing for a diverse range of ways in which the camera may subsequently be handled.

Indeed, a consumer may purchase a fully assembled camera of substantial quality at a lower price than would previously have been obtainable, in part because the component costs can be spread across a number of cycles of re-use of the modules. Conversely, the consumer may obtain a camera body and an imaging module separately and assemble the modules together. The consumer can make a choice among a number of different camera body styles for use with an imaging module, ranging from a conventional camera shape to novelty shapes such as, for example but not limited to, shapes suitable for wearing as pendants. The camera body module including the lens may be re-used independently of re-use of the imaging unit.

In further embodiments of the invention, the imaging module 200 may be designed to physically couple to the camera body to ensure alignment of the image sensor 212 with the lens 330. In this example, the embodiment of FIG. 8 may be adapted so that the imaging module 200 has an annular ridge encircling the image sensor 212 to couple, by, for example but not limited to, a push-fit coupling, with the lens-aligned internal annular rim 336 of the body 300. Indeed, such an arrangement could be implemented in simplified designs where the camera body 300 is reduced to substantially no more than a lens 330. The barrel of the lens 330 could couple directly onto the imaging module 200 to give an ultra simple, ultra compact, low cost camera.

The modular arrangement further provides the option for the user to surrender the camera body module 100, 300 either independently of, or together with, the imaging module 200 as compensated for by, for example, the initial lower purchase price of the camera or even cheaper printing of the images. Indeed, the user may even exercise the option to retain the imaging module 200 with stored images as a permanent or semi-permanent record, while at the same time surrendering the camera body module 100, 300 for re-cycling or re-using with a fresh imaging module, or even discarding the camera body module.

In view of the cost savings, the supplier also has the ability to incorporate a relatively good quality lens into the body while maintaining affordability. The lens may be fixed focus or adjustable, with telescopic and/or macro settings, and may even have a motor for focus adjustment. Alternatively or additionally, a relatively good quality (high pixel count) image sensor may be incorporated into the imaging module.

The present application also provides a method of making a digital camera apparatus available to users. The method includes defining an integral imaging module which is adapted to be mounted into and removed from a separate digital camera body as an integral unit. The integral imaging module comprises at least a digital image sensor and a digital image storage device packaged together in the integral unit, but not comprising a lens. The method further includes making available to users, separately, integral imaging modules and digital camera bodies that require the integral imaging modules for function, whereby an imaging module and a digital camera body together form an operational digital camera.

It will be appreciated by one of ordinary skill in the art that a wide range of further approaches to providing an integral imaging module and to assembling it within a camera body could be developed, the embodiments above being merely exemplary but in no way limiting. As one of ordinary skill in the art will appreciate, the integral imaging module and camera body combination could be provided in a range of different form factors. The form factor of the camera body itself could also vary considerably for a particular type of imaging module—only the physical, and where necessary electrical, interface between the two would need to be kept consistent. This would allow the possibility for camera bodies to be provided in very different form factors (as toys, jewelry, clothing etc.).

In contrast to prior low cost digital camera systems, the system of the present application based on this novel modular construction of the modular digital camera is extremely versatile in operation and economical to implement, benefiting both manufacturer and consumer.

I claim at least the following:

1. A digital camera comprising a lens, a digital image sensor to receive an image from the lens, and a digital image storage device, wherein the image sensor and image storage device are packaged together as an integral imaging module which is adapted to be assembled into and disassembled from the digital camera as an integral unit.

2. The digital camera as claimed in claim 1, wherein the imaging module further comprises a processor adapted to control the operation of the digital camera.

3. The digital camera as claimed in claim 2, wherein the processor is adapted to process image data from the image sensor.

4. The digital camera as claimed in claim 1, wherein the imaging module comprises a backing board to which both the image sensor and the image storage device are mounted.

5. The digital camera as claimed in claim 1, wherein, when disassembled from the digital camera, the imaging module is adapted for direct connection to an interface of a device capable of accessing images stored in the image storage device.

6. The digital camera as claimed in claim 5, wherein the image module is configured as a storage card and the interface is configured for connection to a card reader.

7. The digital camera as claimed in claim 5, wherein the device is a printer.

8. The digital camera as claimed in claim 5, wherein the device is a computer.

9. The digital camera as claimed in claim 1, wherein the image sensor is covered by a protective cover that is removable to expose the image sensor for use.

10. The digital camera as claimed in claim 1, wherein the imaging module is ensheathed in a protective casing.

11. The digital camera as claimed in claim 10, wherein the protective casing has a transparent portion for visually exposing the image sensor.

12. The digital camera as claimed in claim 10, wherein the protective casing has an aperture to operatively expose a contact of the imaging module, the protective casing further having a cover element to cover the aperture when the imaging module is not assembled into the digital camera.

13. The digital camera as claimed in claim 12, wherein the cover element is biased to cover the aperture and cooperates with a camera body module of the digital camera to move the cover element to expose the contact when the imaging module is inserted into the camera body module.

14. The digital camera as claimed in claim 13, wherein the protective casing has a window to operatively expose the image sensor, the protective casing further having a sensor cover to cover the window when the imaging module is not inserted in the camera body module.

15. The digital camera as claimed in claim 14, wherein the sensor cover is connected to the cover element and moves in conjunction therewith to expose the image sensor when the imaging module is inserted in the camera body module.

16. The digital camera as claimed in claim 14, wherein the sensor cover is biased independently from the cover element to cover the window and cooperates with the camera body module to move the sensor cover to expose the image sensor when the imaging module is inserted in the camera body module.

17. The digital camera as claimed in claim 1, wherein the lens is mounted on a camera body adapted to engage the imaging module.

18. The digital camera as claimed in claim 17, wherein the camera body incorporates a guide surface to position the imaging module relative to the lens when the imaging module is fully inserted in the camera body.

19. The digital camera as claimed in claim 17, wherein the camera body has a mounting surface adjacent the rear face of the lens for positioning the imaging module coplanar with and distanced from the lens.

20. A digital camera as claimed in claim 19, wherein the mounting surface aligns the imaging module with the lens.

21. The digital camera as claimed in claim 17, wherein the camera body has a chamber to accommodate the imaging module.

22. The digital camera as claimed in claim 21, wherein the camera body has an access slot to enable insertion and removal of the imaging module into the chamber.

23. The digital camera as claimed in claim 21, wherein the camera body has a door to enable insertion and removal of the imaging module into the chamber.

24. The digital camera as claimed in claim 23, wherein the door is configured to align the imaging module with the lens of the camera body as the door is closed.

25. The digital camera as claimed in claim 23, wherein the door is configured to press electrical contacts of the imaging module into engagement with corresponding contacts of the camera body as the door is closed.

26. The digital camera as claimed in claim 23, wherein the door has a pocket into which the imaging module fits.

27. The digital camera as claimed in claim 17, wherein the camera body has an ejector to eject the imaging module from within the camera body.

28. The digital camera as claimed in claim 17, wherein the camera body comprises a molding of compressed plastic-coated cardboard material shaped to form the camera body.

29. An imaging module for use in cooperation with a digital camera body, the imaging module comprising:
a digital image sensor; and
a digital image storage device;
wherein the digital image sensor and digital image storage device are packaged together as an integral imaging module, which is adapted to be assembled into and disassembled from the digital camera body as an integral unit.

30. The imaging module as claimed in claim 29, further comprising a processor adapted to control the operation of a digital camera.

31. The imaging module as claimed in claim 30, wherein the processor is adapted to process image data from the image sensor.

32. The imaging module as claimed in claim 29, further comprising a backing board to which both the image sensor and the image storage device are mounted.

33. The imaging module as claimed in claim 29, further adapted for communication with a device via an interface.

34. The imaging module as claimed in claim 33, wherein the image module is configured as a storage card and the interface is configured for connection to a card reader.

35. The imaging module as claimed in claim 33, wherein the device is a printer.

36. The imaging module as claimed in claim 33, wherein the device is a computer.

37. The imaging module as claimed in claim 29, further comprising a protective cover that covers the image sensor and is movable or removable to expose the image sensor for use.

38. The imaging module as claimed in claim 29, wherein the imaging module is ensheathed in a protective casing.

39. The imaging module as claimed in claim 38, wherein the protective casing is transparent or has a transparent portion for exposing the image sensor.

40. The imaging module as claimed in claim 38, wherein the protective casing has an aperture to operatively expose the imaging sensor, a contact of the imaging module, or both, the protective casing further having a cover element to cover the aperture when the imaging module is not accommodated within the digital camera body.

41. A camera body comprising a lens but not comprising an image sensor or an image storage device, the camera body being dimensioned to accommodate an imaging module comprising at least an image sensor and an image storage device and having a guide to substantially correctly position the imaging module relative to the lens when the imaging module is inserted within the camera body.

42. The camera body as claimed in claim 41, wherein the camera body has a chamber to accommodate the imaging module.

43. The camera body as claimed in claim 42, wherein the camera body has an access slot to control access to the chamber enabling insertion and removal of the imaging module.

44. The camera body as claimed in claim 42, wherein the camera body has a door to control access to the chamber enabling insertion and removal of the imaging module.

45. A method of making digital camera apparatus available to users, comprising:
defining an integral imaging module which is adapted to be removably received into a digital camera body as an integral unit, the integral imaging module comprising at least a digital image sensor and a digital image storage device packaged together in the integral unit, but not comprising a lens;
making available to users, separately, integral imaging modules and digital camera bodies, whereby an integral imaging module and a digital camera body together form an operational digital camera.

46. The method as claimed in claim 45, wherein the integral imaging modules are provided with different specifications for the digital image sensor.

47. The method as claimed in claim 46, wherein the digital camera bodies are provided in a variety of different physical forms.

48. The method as claimed in claim 47, wherein at least some of the digital camera bodies are provided without integral imaging modules and at least some of the integral imaging modules are provided without digital camera bodies.

49. A method of operating a digital camera, the method comprising:
providing an imaging module having an image sensor and a storage device;
providing a separate camera body module having a lens;
installing the imaging module into the camera body module; and
activating the image sensor to sense an image from the lens.

50. The method as claimed in claim 49, wherein providing the camera body module further comprises providing a camera body module having a chamber, and installing the imaging module further comprises installing the imaging module into the chamber.

51. The method as claimed in claim 49, further comprising:
removing the imaging module from the camera body module; and
processing an image stored on the storage device.

52. A digital camera comprising:
means for focusing an image;
means for sensing an image from the focusing means;
means for storing an image sensed by the sensing means; and
means for enabling the sensing means and storing means to be removably assembled with the focusing means.

53. The digital camera as claimed in claim 52, further comprising:
means for housing the focusing means and removably housing the enabling means.

54. The digital camera as claimed in claim 53, further comprising means for aligning the focusing means with the sensing means when the enabling means is housed within the housing means.
